(19) United States
(12) Patent Application Publication
(10) Pub. No.: US 2005/0144488 A1
(43) Pub. Date: Jun. 30, 2005

(54) Method and apparatus of lowering I/O bus power consumption

(76) Inventors: Victor W. Lee, San Jose, CA (US); Phanindra K. Mannava, Folsom, CA (US); Akhilesh Kumar, Sunnyvale, CA (US); Sanjay Dabral, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/810,119

(22) Filed: Mar. 25, 2004

Related U.S. Application Data
(63) Continuation-in-part of application No. 10/750,041, filed on Dec. 30, 2003, now abandoned.

(51) Int. Cl. G06F 1/26

(52) U.S. Cl. 713/300

(57) ABSTRACT

The current method and apparatus provides a novel approach to manage the power consumption of a high speed I/O interface by selectively turning off non-essential portions of the interface. Here only part of the interface is powered off as compared to the whole interface being turned off. From the upper layers (protocol/system) perspective, the interface is always “on”. Thus, this mechanism reduces link power by selectively turning off portions of the link, yet allowing for fast wake up in an interface power management architecture.

### RELATED APPLICATIONS

This application is a continuation-in-part of application Ser. No. 10/750,041, filed Dec. 30, 2003.

### BACKGROUND INFORMATION

Many mechanisms have been developed to manage electronic device/component power. Intel and other companies have drafted an ACPI (Advanced Configuration and Power Interface) specification which uses multistage approach to scale power consumption with usage. However, the ACPI specification does not provide actual implementation for power management. This deficiency leads individual hardware providers to design and implement their own power management methods.

In the area of interface power management there are two common methods for lowering bus power consumption. First, by lowering the I/O interface frequency and secondly, by turning off the entire I/O interface when not used.

One of the fundamental flaws of these existing methods is that changing the interface frequency on the fly is complicated and a large settling time is required to stabilize the interface after the frequency change. Furthermore, turning on the interface from the power off mode requires a complete re-initialization of the entire interface. No mechanism is available in the current architecture to provide intelligent handling of allowing each direction of a link to operate at low or normal power mode, independently, while still keeping the links alive when in low power mode. Therefore, a mechanism to reduce link power by selectively turning off portions of the link, yet allowing for fast wake up in an interface power management architecture is desired.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a block diagram illustrating communication between typical layers in a multi-layer network.

FIG. 2 is a bock diagram of a packet of data.

FIG. 3a is a block diagram illustrating one example of a communication between a transmitter and receiver pair.

FIG. 3b is a block diagram illustrating one example of a communication between a transmitter and receiver pair to a microprocessor.

FIG. 4 is a flowchart representing the operation of the transmitter and receiver transitioning into low power mode.

FIG. 5 is one example of a packet in low power mode.

FIG. 6 is a flowchart representing the operation of the transmitter and receiver waking up from low power mode.

FIG. 7 is one example of the packet in FIG. 5 waking up from low power mode.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

This application is regarding I/O buses that connect different components together in a computer system. The type of I/O buses the present application is concerned with are known as links. A link is a point-to-point interconnect connecting two components (these components can be on the same circuit board or across two different boards). A link is always bi-directional and consists of an out-going direction and an in-coming direction. The width of the link is scalable from one bit (a.k.a. serial) to multiple bits in parallel. A single bit may be transferred from a source component via a transmitter and received at a destination component via a receiver. In multi-bit parallel links, multiple bits are transferred simultaneously in parallel through multiple transmitter and receiver pairs. This signaling technology can be single ended or differential.

The power consumed by a link scales almost linearly with the width of the link (i.e. the number of serial I/O channels). The power also scales with the frequency of the I/O channels. Thus, a significant portion of the I/O channel is consumed by the transmitter and receiver pair. For example, a 16-bit bi-directional I/O bus running at 3.2 GT/s can easily consume 2 W of power. When multiple I/O buses are integrated into a component, the I/O power consumption can take up a significant portion of the components' power budget. As an example, for a CPU with 6 links, the power budget for I/O buses could be 12 W or 10% of a 120 W CPU thermal budget. This does not include the power for the Link and Protocol stack. By having coordinated shut down of certain link components can easily save 1 W of power per link.

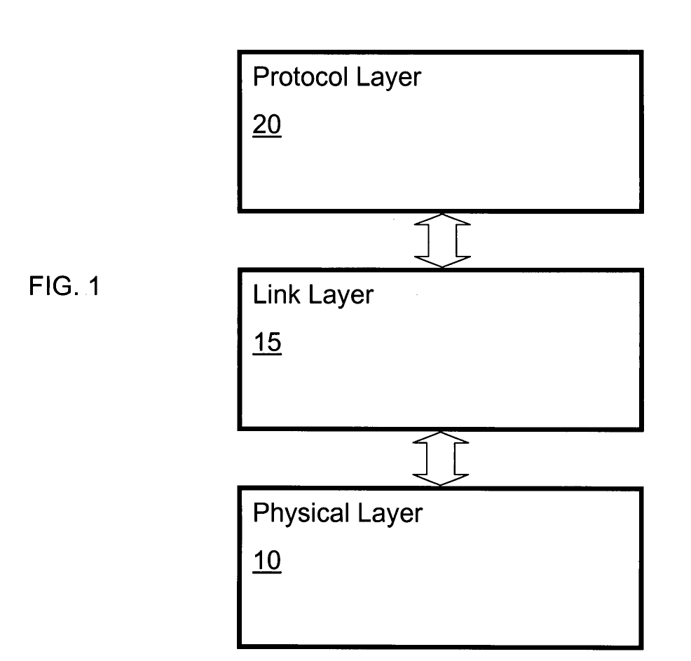

FIG. 1 is a block diagram of a protocol stack. In some embodiments, a protocol stack can be portioned into at least three layers. Each layer performs a well-defined set of protocol functions. The layering results in a modular architecture that is easier to specify, implement and validate. The layers from bottom to top are the physical layer 10, the link layer 15, and the protocol layer 20. The physical layer 10 is a point-to-point interface between any two agents in a multi-layer network. The physical layer 10 is responsible for electrical transfer of information on a physical medium, such as transmitting of data bits. The electrical transfer is achieved by not requiring the physical layer 10 to support any protocol level functionality.

The link layer 15 abstracts the physical layer 10 from the protocol layer 20, thus, guaranteeing reliable data transfer between agents in a multi-layer network. In addition, the link layer 15 is responsible for flow control between the two agents in a multi-layer network. The link layer 15 requires both ends of the link to perform its functions to ensure reliable delivery of data.

The protocol layer 20 implements the platform dependent protocol engines for higher level communication protocol. The protocol layer 20 may use packet based protocol for communication.

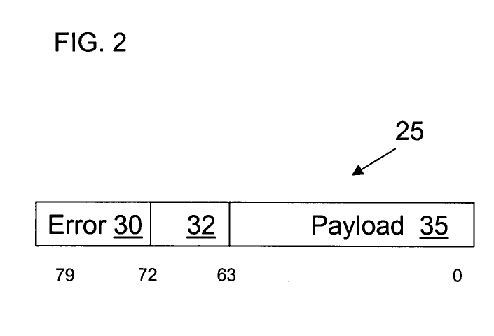

FIG. 2 illustrates a packet of data. For illustration purposes, the data packet 25 shows 80 bits typically transmitted in one clock cycle. Packets of data may be transferred through the multi-layer network in units referred to as flits. A message can come in several different lengths: one flit, two flit or four flits. A flit could contain any number of bits. Of these flits, some of the bits are used for error detection 30 and control signals 32 known as sideband and other bits are used for the actual message, referred to as payload 35. As described above, the protocol layer communicates using a packet-based protocol. The mechanism to enable reliable transfer of flits requires some form of error correction.

A number or schemes exist for correcting errors and detecting corruption of data during transport, for example, data transmitted between agents over a network. One example of a scheme for detecting errors in a data field is parity. When data is transmitted, a parity generator appends an additional parity bit to the data.

Another example of an error detection scheme is a CRC (cyclic redundancy check) checksum. CRC uses special check-sum computation algorithm and polynomial to ensure data integrity in transmission. Error my be detected by checking the transmitted check-sum with computed check-sum at the receiving end.

Closely related to the CRC are ECC codes (error correcting or error checking and correcting). ECC codes are in principle CRC codes whose redundancy is so extensive that they can restore the original data if an error occurs that is not too disastrous.

As previously stated, each link consumes a significant amount of power. Turning the links on and off is not like a switch that can turn on or off automatically. There are protocols the link has to follow before turning on or off, such as, conserving the current state. Since the physical layer is comprised of an analog circuit, there is a lengthy initialization sequence that must be followed to turn a link on if it is in the off state. Link initialization may include: electrical calibration, clock synchronization, channel to channel diskewing, framing, and synchronization of operating parameters. This initialization sequence can take up to millions of cycles to complete. By contrast, the current protocol allows the link to power up in tens of cycles.

Most packets of communication used in high speed interconnects consists of a command portion and a data portion. When a packet is idle, the data portion is not used by the protocol layer and the link goes into low power mode. Agents associated with that data portion can be turned off when not used. The protocol layer may not have knowledge that the link is in low power mode. If the protocol layer wants to transmit data, it may do so. The link layer will wake up the link to transmit data.

By entering into low power mode, power saving is achieved by selectively turning off these non-essential parts in the physical layer. Since the link layer has knowledge that it is in the low power mode, it will not transmit data and will maintain idle mode. The benefits of power savings include allowing power scaling for I/O bus based on utilization, improved component power management and in-band power management signaling.

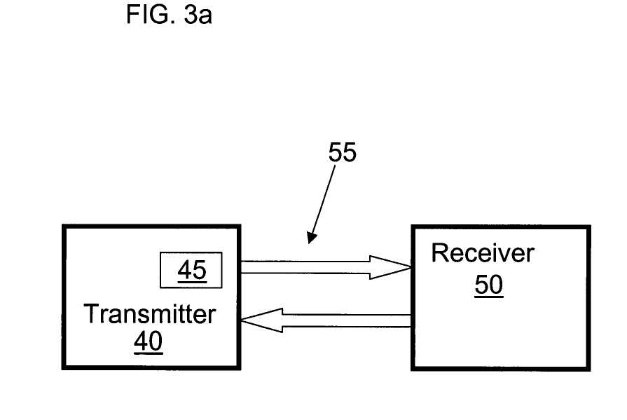

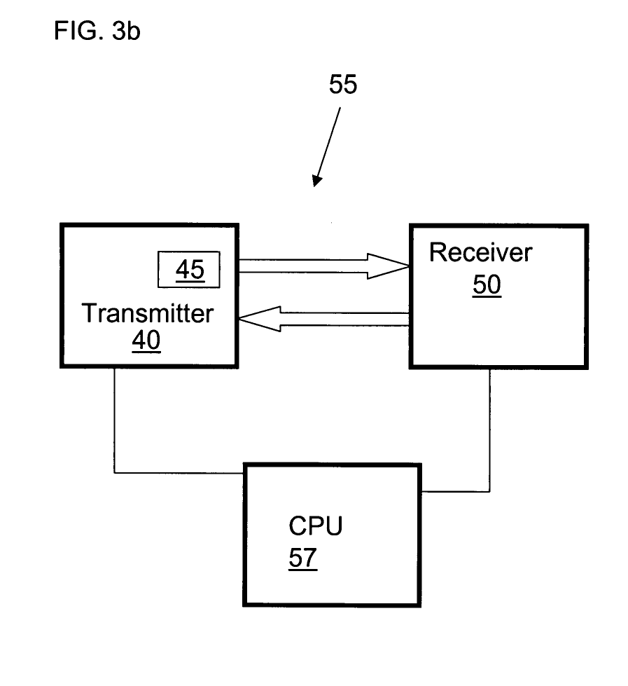

Referring to FIG. 3a, a transmitter 40 includes a link activity monitor 45. The activity monitor 45 can be either hardware or software and may be part of the link or protocol layer. The activity monitor 45 monitor's the activity on this particular link. The monitor 45 notifies the control logic on the link to take some action based on what the monitor 45 has detected. If there is no activity on this link for a period of time the control logic sends a signal to a receiver 50. This signal command may be a sleep command 55. Thus, power management can be applied to each direction of traffic (transmitter to receiver or receiver to transmitter), independently. The transmitter and receiver may also be connected to a microprocessor 57 as illustrated in FIG. 3b.

The command 55 may be, for example, a packet made of 80 bits. A link comprised of 20 pairs of transceivers, each transceiver transmits 1 bit of information. Thus for each cycle, 20 bits are transferred. In order to transfer 80 bits it will take 4 cycles, 20 bits per cycle. The size of the link can be changed to fit the implementation.

The transmitter and receiver pairs may go into sleep mode in one of two operations. The sleep command 55 may be initiated by either the transmitter or receiver. For illustration purposes, the following example is assuming the transmitter 40 initiated the sleep command. In the first operation, the transmitter 40 will send a request 55 to the receiver 50 to go to sleep. Prior to sending the sleep request 55, the transmitter may format the request 55. The transmitter 40 may then start a timer. Upon expiration of the timer, the transmitter 40 will automatically assume that the receiver 50 has received the sleep command 55 and the transmitter 40 will go to sleep. In this operation, the receiver 50 receives the command 55, saves its buffers and goes to sleep.

In the second operation, upon receiving a sleep command, the transmitter formats the request 55 and sends the sleep command 55 to the receiver 50 to go to sleep. When the receiver 50 receives the sleep command 55, it saves all of its buffers, sends an acknowledgement to the transmitter that it is going to sleep. Once the transmitter 40 receives the acknowledgement from the receiver 50, the transmitter 40 then goes into low power mode.

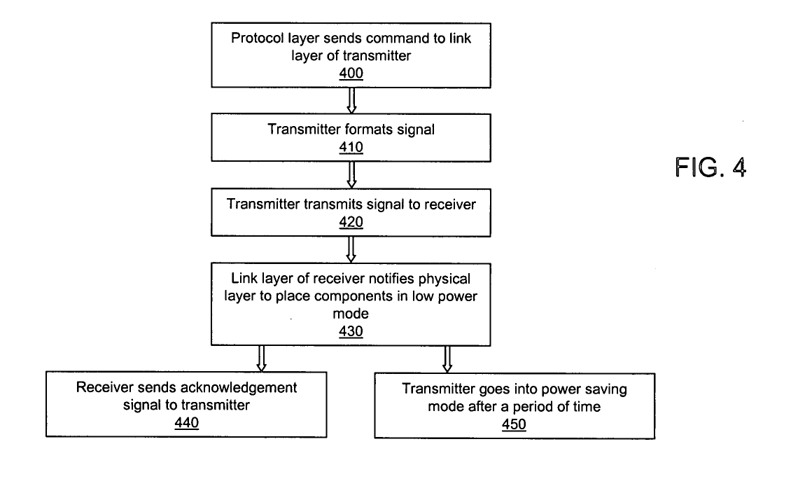

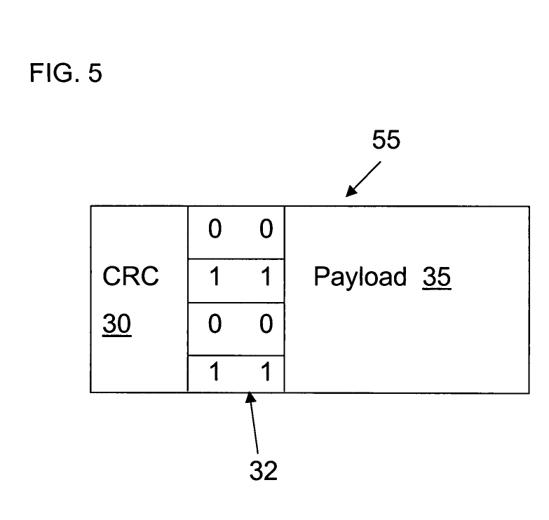

Referring now to FIGS. 4 and 5, where FIG. 4 is a flowchart illustrating one sequence of operation of the transmitter and receiver pair going into low power mode and FIG. 5 is an illustration of the corresponding data packet when in low power mode. To maintain high error detection capabilities, CRC 30 is computed over the whole message, 80 bits, while assuming the bits in the data channels that are tuned off to have a static value. In FIG. 5, 16 of the wires of the payload 35 may be turned off and 4 of the wires 32 may be kept on. It should be noted that there are multiple ways of implementing error detection on the link and that CRC is just one implementation and other implementations may be used, such as ECC and parity.

In FIG. 4, the data link layer on the transmitter 40 may receive a command from the link activity monitor 45 or the protocol layer of the transmitter 40 to place the link in light sleep mode (step 400). The transmitter 40 may then format the packet (step 410). Within the packet, the transmitter 40 may set the bits in the unused portion of the packet to zero, compute the CRC checksum and assign a static value to the bits kept on in the packet before transmitting the packet. In FIG. 5, this value is 00, 11, 00, 11. The transmitter 40 then sends the sleep command 55 to the receiver 50 (step 420). When the receiver 50 receives the sleep command 55, the receiver 50 may make some assumptions. First, the receiver 50 will assume that the input is 0 on the 16 wires of the payload 35. The receiver 50 computes a CRC checksum calculation to see if there are any errors in the transmission of the signal. The receiver 50 needs to check for errors because the link is never idle, there is always something being sent on the link.

CRC is computed in a link layer packet basis (both on the transmitter and receiver ends). The transmitter 40 computes the CRC and transmits it as part of the command portion and the receiver 50 recomputes the CRC and compares it with the transmitted CRC to see if any transmission error occurs. The receiver 50 may use any of the well know error detection methods discussed above. In particular, the receiver 50 may assume input flit payload to have a static value of all zeros. This static value can be any logical value such as all zeros, all ones, etc. The receiver 50 then goes into low power mode. The link layer in the receiver 50 notifies its physical layer to turn off components corresponding to the data bits turned off (step 430). Once the receiver 50 is in low power mode, the receiver 50 can send an acknowledgement signal to the transmitter 40 that it is now in low power mode (step 440). Otherwise, the transmitter may set a timer and upon expiration of the timer, the transmitter 40 will go into sleep mode (step 450).

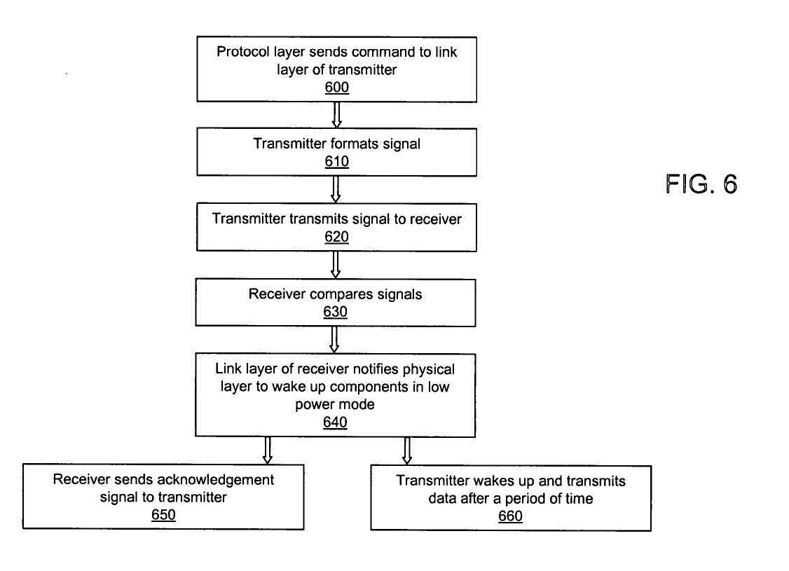

Referring now to FIG. 6, a flowchart illustrates one sequence of operation of the transmitter and receiver pair waking up from low power mode. Beginning with step 600, the data link layer of the transmitter 40 may receive a wake up command from either the link activity monitor 45 or the protocol layer of the transmitter 40. Upon receiving the wake up command, the transmitter 40 formats the signal (step 610). The transmitter 40 wakes up (using the current example) all 16 wires of the payload 35. There are only 16 wires to turn on because 4 of the wires 32 were never turned off as shown in FIG. 5. At this time, all data payloads 35 are still assumed to have a static value of zero.

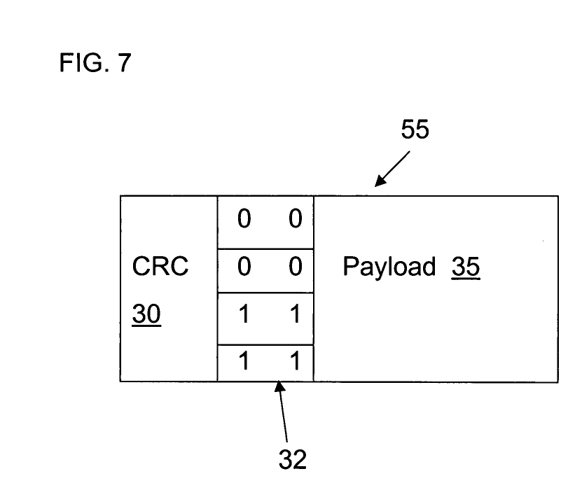

Once all 16 wires are on, the transmitter 40 will change the pattern in the 4 wires that were left on 32. As shown in FIG. 5, the 4 wires that were left on have a particular pattern or value. In this instance, the pattern is 00, 11, 00, 11. This pattern is the command that notifies the transmitter and receiver to go to sleep or to wake up. It should be noted that the wires may have any pattern having any value to fit the implementation. In flit type commands, the sideband signal 32 may be encoded. By changing the sideband signal, a different command is assumed. This is how a corresponding agent knows to go to sleep or to wake up. Now that the transmitter 40 is waking up from sleep mode, the transmitter 40 will change the pattern of the 4 wires on the sideband signal 32 that were left on. In this instance, as shown in FIG. 7, the transmitter 40 has changed the pattern to 00, 00, 11, 11. Once the receiver 50 receives the signal having the new pattern (step 620), the receiver 50 compares the original pattern 32 to the new pattern 32. When the receiver 50 identifies that the pattern of the sideband 32 has changed, it wakes up the components in low power mode. The link layer of the receiver 50 notifies the physical layer to wake up the components that were in low power mode (step 640). Once the receiver 50 wakes up, the receiver 50 may send an acknowledgement signal to the transmitter 40 (step 650) or after a period of time, the transmitter 40 will start transmitting its data (step 660).

In the method disclosed, the interface actually behaves like it is in the idle mode. Therefore, from the upper communication layers (protocol layer, system firmware, system OS) perspective, the link is still active. This reduces software complexity. Moreover, keeping the link alive during power saving mode allows the link to maintain its operation (such as passing credits/acks back and forth between agents as well as providing CRC checksum against transmission error). These features are unique to the method disclosed above and do not exist in current methods.

The current method further provides a novel approach to manage the power consumption of a high speed I/O interface by selectively turning off non-essential portion of the interface. Here only part of the interface is powered off as compared to the whole interface being turned off and by keeping part of the interface on, the current method maintains the interface operation state. This method may provide significant power savings, sometimes up to greater than 80%. Thus, from the upper layers (protocol/system) perspective, the interface is always “on”.

Since the link is still operating in full speed (only in a scaled back fashion) the link may return to full bandwidth operation in a matter of ten cycles. Furthermore, the link wake up latency can be completely hidden from the upper link layers. This may be accomplished by programming the data link layer to wake up the physical layer as soon as it receives a request from the protocol layer. This way, the physical layer can perform link wake up protocol while the data link layer process the request.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

1. A method for power management, comprising:
formatting a message based on received command;
transmitting the formatted message; and
selectively powering down components based on the formatted message.

2. The method of claim 1 further comprising receiving a command.

3. The method of claim 1 wherein formatting a message further comprising:
setting bits in payload portion of the message; and
assigning a first value to sideband portion of the message.

4. The method of claim 1 wherein formatting a message further comprising analyzing the formatted message for error.

5. The method of claim 3 wherein selectively powering down components associated with the payload portion of the message.

6. The method of claim 3 further comprising:
reformatting the message based on a received command; and
transmitting the reformatted message; and
selectively powering up components based on the reformatted message.

7. The method of claim 6 further comprising receiving a command.

8. The method of claim 6 wherein reformatting the message further comprising:
setting bits in the payload portion of the message; and
assigning a second value to the sideband portion of the message.

9. The method of claim 6 wherein reformatting the message further comprising analyzing the reformatted message for error.

10. The method of claim 8 further comprising comparing the first and second values of the sideband portion of the messages.

11. The method of claim 10 wherein selectively powering up components based on result of comparing the first and second values.

12. An apparatus for power management, comprising:
a first device formats a message based on a received command;
a second device coupled to the first device receives the formatted message, wherein the first and second devices selectivity power down components based on the formatted message.

13. The apparatus of claim 12 wherein the first device comprises an activity monitor.

14. The apparatus of claim 13 wherein the activity monitor transmits the command to the first device.

15. The apparatus of claim 12 wherein the first device assigns a first value to the sideband portion and the payload portion of the message.

16. The apparatus of claim 15 further comprising:
the first device reformats the message based on a received command; and
the second device receives the reformatted message and the first and second devices selectively power up components based on the reformatted message.

17. The apparatus of 16 wherein the first device assigns a second value to the sideband portion and the payload portion of the message.

18. The apparatus of claim 17 wherein the second device compares the first and second values of the sideband portion of the message.

19. The apparatus of claim 18 wherein the first and second devices selectively power up the components based on result of comparison.

20. The apparatus of claim 17 wherein the second device transmits an acknowledgement signal to the first device.

21. The apparatus of claim 17 wherein the first device transmits data after a period of time.

22. A system for power management, comprising:
a microprocessor;
a first device coupled to the microprocessor;
a second device coupled to the first device and the microprocessor, wherein the first and second device comprising:
the first device formats a message based on a received signal;
the second device receives the formatted message and the first and second devices selectively power down components based on the formatted signal.

23. The system of claim 22 wherein the first device assigns a first value to the sideband and payload portions of the message.

24. The system of claim 23 further comprising:
the first device reformats the message based on a received command; and
the second device receives the reformatted message and the first and second devices selectively powers up components based on the reformatted message.

25. The system of claim 24 wherein the first device assigns a second value to the sideband portion and the payload portion of the message.

26. The system of claim 25 wherein the second device compares the first and second values of the sideband portion of the message.

27. The apparatus of claim 26 wherein the first and second devices selectively power up components based on result of comparison.
